(19) United States
(12) Patent Application Publication
(10) Pub. No.: US 2018/0217717 A1
(43) Pub. Date: Aug. 2, 2018

(54) PREDICTIVE VEHICULAR HUMAN-MACHINE INTERFACE

(71) Applicant: Toyota Research Institute, Inc., Los Altos, CA (US)

(72) Inventors: Hiroshi Yasuda, San Francisco, CA (US); Julian M. Mason, Redwood City, CA (US)

(21) Appl. No.: 15/420,100

(22) Filed: Jan. 31, 2017

(51) Int. Cl. G06F 3/0482; G06F 3/0481; B60K 35/00

(52) U.S. Cl. CPC G06F 3/0482; G06F 3/011; B60K 35/00; G06F 3/04817

(57) ABSTRACT

A device and method for a predictive human-machine interface are disclosed, in which a vehicular transition event may be detected by monitoring a plurality of sensor data. When the vehicular transition event occurs, a prediction for the vehicle-user input response to the vehicular transition event is formed, and a predictive vehicle-user input response is produced. Based on the predictive vehicle-user input response, display data for emphasizing a subset of a plurality of presented user interface elements is generated to facilitate a vehicle-user input.

### FIELD

The subject matter described herein relates in general to human-machine interface devices and, more particularly, to a predictive vehicular human-machine interface according to a vehicular transition event.

### BACKGROUND

Human-machine interface (HMI) devices are generally intended to provide user interfaces that are easy and/or self-explanatory, efficient, and user-friendly for operating a vehicle to produce a desired operational result. HMI device efficiencies may be increased by requiring minimal user input to achieve a desired machine result, while also minimizing undesired vehicle feedback information to the user. Desired is a human-machine interface that provides predictive capability to a vehicle user's user input selection, while providing non-obtrusive access to other vehicle user inputs to the vehicle user.

### SUMMARY

A device and method for a predictive human-machine interface are disclosed.

In one implementation, a method in a vehicle control unit for a predictive vehicular human-machine interface is disclosed. The method comprises detecting a vehicular transition event by monitoring a plurality of sensor data. When the vehicular transition event occurs, a prediction for the vehicle-user input response to the vehicular transition event, and producing a predictive vehicle-user input response. Based on the predictive vehicle-user input response, display data for emphasizing a subset of a plurality of presented user interface elements is generated to facilitate a vehicle-user input.

In another implementation, a predictive vehicular human-machine interface device is disclosed. The device includes a processor, and memory communicably coupled to the processor. The memory stores a vehicular transition event module, a prediction module, and a display generation module. The vehicular transition event module includes instructions that when executed cause the processor to detect a vehicular transition event based on a plurality of sensor data. The prediction module includes instructions that when executed by the processor predict a vehicle-user input response to the vehicular transition event and generates a predictive vehicle-user input response therefrom. The display generation module includes instructions that when executed by the processor generates, based on the predictive vehicle-user input response, display data to emphasize a subset of a plurality of presented user interface elements for vehicle-user input.

### BRIEF DESCRIPTION OF THE DRAWINGS

The description makes reference to the accompanying drawings wherein like reference numerals refer to like parts throughout the several views, and wherein:

FIG. 1 is a schematic illustration of a vehicle including a vehicle control unit;

FIG. 2 illustrates a head unit control surface of the vehicle of FIG. 1;

FIGS. 3A and 3B are example illustrations of a home or non-emphasized display and an emphasized display for the head unit control surface of FIG. 2;

FIG. 4 illustrates vehicle-user preference data for predicting a vehicle-user input response;

FIG. 5 illustrates a functional block diagram for a predictive human-machine interface of the vehicle control unit of FIG. 1;

FIG. 6 is a block diagram of a vehicle control unit of FIG. 1; and

FIG. 7 shows an example process for a predictive vehicular human-machine interface.

### DETAILED DESCRIPTION

A predictive vehicular human-machine interface (HMI) for facilitating a probable vehicle-user input of a plurality of possible vehicle-user inputs is disclosed.

Human-machine interface (HMI) devices are intended to provide user interfaces that are easy and/or self-explanatory, efficient, and user-friendly for operating a vehicle to produce a desired operational result. HMI device efficiencies may be increased by requiring minimal user input to achieve a desired machine result, while also minimizing undesired vehicle feedback information to the user.

For example, upon detecting a vehicular transition event, such as a speed decrease, approaching traffic congestion, a change weather conditions, change in terrestrial/satellite radio station content, etc., a vehicle control unit operates to minimize the amount of user information input by operating to predict a vehicle-user input response to the vehicular transition event to produce a predictive vehicle-user input response, which may then operate to emphasize a subset of presented user interface elements in contrast with a remainder of a set of presented user interface elements relating to media content playback.

Emphasis applied to a subset of a plurality of presented user interface elements may include, for example, highlighting display icons (such as by an enlarged icon, a brighter color scheme, pulsing depiction, relocate for easier vehicle user access, etc.), backlighting control switches within the vehicle cockpit, etc.

By emphasizing a subset of the many presented user interface elements, the predictive vehicular human machine interface provides a user interface that can be easy and/or self-explanatory to use, efficient, and user-friendly for operating a vehicle to produce a desired operational result.

Predictive behavioral modeling may be based on specific vehicle user behaviors (that is, micro-behavioral modeling) for those individuals that may frequently use the vehicle, such as the tastes, likes, dislikes, etc., for the vehicle owner, their significant others, children, and so on. Predictive behavioral modeling may be based on general vehicle user and/or of a simulated model (or general) user behaviors (that is, macro-behavioral modeling), such as regional driving customs, preferences, etc., for the “average” driver.

Specific vehicle user behaviors may include choices in music, in playback volume, in work commute routines, etc. Feedback data may be collected by the vehicle control unit while a vehicle is operated to develop behavioral patterns of a vehicle operator with respect to vehicle transition events and user interfaces that may be engaged. Modeled behavioral models may similarly be developed by observing general behaviors within a vehicle and/or based on simulated vehicle scenarios.

In operation, when a subsequent vehicle transition event occurs, the vehicle control unit may retrieve vehicle user preference data, which may include probability values for each of presented user interface elements. Based on the vehicle user preference data, the vehicle control unit may operate to generate display data emphasizing some of a plurality of presented user interface elements (such as touch screen-based icons, and/or tactile buttons, switches, etc.).

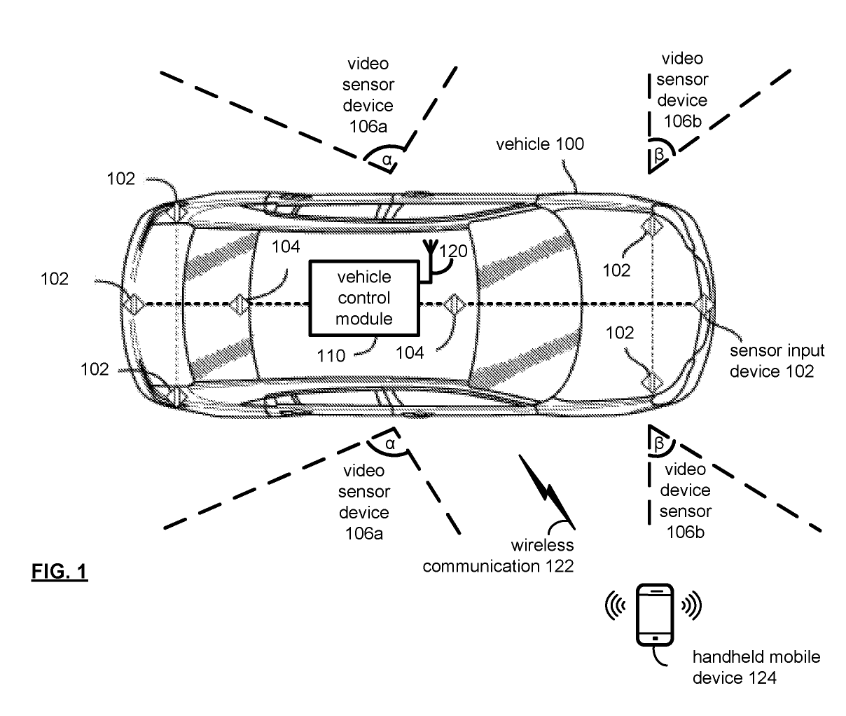

The device and method relating to the vehicular human-machine interface of a vehicle control unit are discussed in detail with reference to FIGS. 1-7.

FIG. 1 is a schematic illustration of a vehicle 100 including a vehicle control unit 110. A plurality of sensor devices 102, 104, 106a and 106b are in communication with the control unit 110.

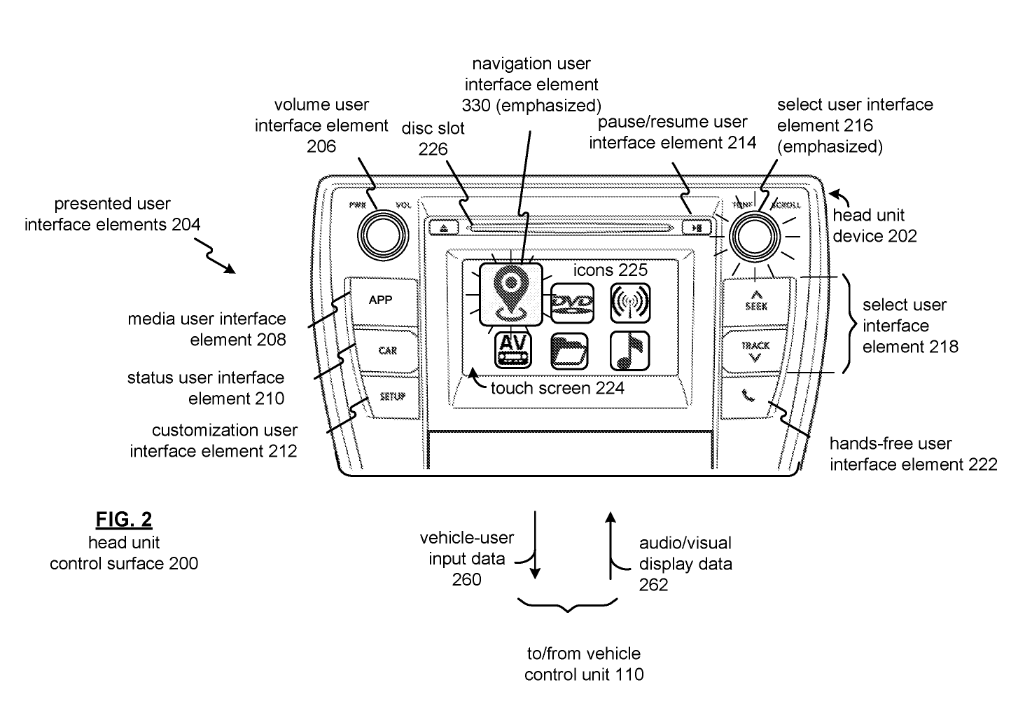

The vehicle control unit 110 may include an antenna 120 coupled to a wireless communications interface to provide wireless communication with the unit 110, which is discussed in detail with reference to FIGS. 2-7.

The plurality of sensor devices 102, 104 and/or 106 may be positioned on the outer surface of the vehicle 100, or may be positioned in a concealed fashion for aesthetic purposes with regard to the vehicle. Moreover, the sensors may operate at frequencies in which the vehicle body or portions thereof appear transparent to the respective sensor device. As may be appreciated, one or more of the sensor devices 102, 104 and/r 106 may be configured to capture changes in velocity, acceleration, and/or distance to these objects in the ambient conditions of the vehicle 100, as well as an angle of approach.

Communication between the sensors and vehicle control units, including vehicle control unit 110, may be on a bus basis, and may also be used or operated by other systems of the vehicle 100. For example, the sensor devices 102, 104 and/or 106 may be coupled by a combination of network architectures such as a Body Electronic Area Network (BEAN), a Controller Area Network (CAN) bus configuration, an Audio Visual Communication-Local Area Network (AVC-LAN) configuration, and/or other combinations of additional communication-system architectures to provide communications between devices and systems of the vehicle 100.

The sensor devices may include sensor input devices 102, audible sensor devices 104, and video sensor devices 106a and 106b. The outputs of the example sensor devices 102, 104, and/or 106 may be used by the vehicle control unit 110 to detect vehicular transition events, which may then predict a vehicle-user input response. The predicted vehicle-user input response may then be used by the vehicle control unit 110 to emphasize a subset of presented user interface elements for facilitating a vehicle-user input as will be discussed in detail below.

The sensor input devices 102, by way of example, may provide tactile or relational changes in the ambient conditions of the vehicle, such as an approaching pedestrian, cyclist, object, vehicle, road debris, and other such vehicle obstacles (or potential vehicle obstacles).

The sensor input devices 102 may be provided by a Light Detection and Ranging (LIDAR) system, in which the sensor input devices 102 may capture data related to laser light returns from physical objects in the environment of the vehicle 100. The sensory input devices 102 may also include a combination of lasers (LIDAR) and milliwave radar devices.

The audible sensor devices 104 may provide audible sensing of the ambient conditions of the vehicle 100. With speech recognition capability, the audible sensor devices 104 may receive instructions to move, or to receive other such directions. The audible sensor devices 104 may be provided, for example, by a nano-electromechanical system (NEMS) or micro-electromechanical system (MEMS) audio sensor omnidirectional digital microphone, a sound-triggered digital microphone, etc.

As may be appreciated, a vehicle interior space may be noise-insulated to improve a passenger and/or operator's travel experience. On the other hand, utility vehicles (such as trucks, construction vehicles, etc.) have little noise insulation. The vehicle interior may be filled with noise pollution from friction from moving air, the roadway, or a construction site. Audible sensor devices 104, which may be mounted within an interior and/or an exterior of the vehicle may provide sensor data that may relate to an approaching person, cyclist, object, vehicle, and other such vehicle obstacles (or potential vehicle obstacles), and such data be conveyed via a sensor control unit to vehicle control unit 110.

The video sensor devices 106a and 106b include sensing associated fields of view. For the example of FIG. 1, the video sensor device 106a has a three-dimensional field-of-view of angle-a, and the video sensor device 106b has a three-dimensional field-of-view of angle-β, with each video sensor having a sensor range for video detection.

In the various driving modes, the examples of the placement of the video sensor devices 106a for blind-spot visual sensing (such as for another vehicle adjacent the vehicle 100) relative to the vehicle user, and the video sensor devices 106b are positioned for forward periphery visual sensing (such as for objects outside the forward view of a vehicle user, such as a pedestrian, cyclist, vehicle, road debris, etc.). For controlling data input from the sensors 102, 104 and/or 106, a respective sensitivity and focus of each of the sensor devices may be adjusted to limit data acquisition based upon speed, terrain, activity density around the vehicle, etc.

For example, though the field-of-view angles of the video sensor devices 106a and 106b may be in a fixed relation to the vehicle 100, the field-of-view angles may be adaptively increased and/or decreased based upon a vehicle driving mode. For example, a highway driving mode may cause the sensor devices to sample ambient conditions less frequently because of the more rapidly changing conditions relative to the speed of the vehicle 100, while a residential driving mode may cause the sensor devices to sample ambient conditions more frequently because of a lower vehicle speed, and time to perhaps react to objects detected in residential and/or urban setting, such as a child's ball crossing in front of the vehicle. A parking mode may increase a sensitivity of the sensor devices 102, 104 and/or 106 for ambient condition changes relative to the vehicle 100.

The vehicle 100 may also include options for operating in manual mode, autonomous mode, and/or driver-assist mode. When the vehicle 100 is in manual mode, the driver manually controls the vehicle control unit modules, such as a propulsion module, a steering module, a stability control module, a navigation module, an energy module, and any other modules that can control various vehicle functions (such as the vehicle climate functions, entertainment functions, etc.).

In autonomous mode, a computing device, which may be provided by the vehicle control unit 110, or in combination therewith, can be used to control one or more of the vehicle systems without the vehicle user's direct intervention. Some vehicles may also be equipped with a “driver-assist mode,” in which operation of the vehicle 100 can be shared between the vehicle user and a computing device. For example, the vehicle user can control certain aspects of the vehicle operation, such as steering, while the computing device can control other aspects of the vehicle operation, such as braking and acceleration. When the vehicle 100 is operating in autonomous (or driver-assist) mode, the computing device 100 issues commands to the various vehicle control unit modules to direct their operation, rather than such vehicle systems being controlled by the vehicle user.

As shown in FIG. 1, the vehicle control unit 110 may be configured to provide wireless communication 122 through the antenna 120, for communication with a handheld mobile device, with other vehicles (vehicle-to-vehicle (V2V)), with infrastructures (vehicle-to-infrastructure (V2I)), and/or with a network cloud.

Such data may be conveyed to vehicle control unit 110 for detecting a vehicular transition event, and emphasizing a corresponding user interface element relating to data from the sensor input device 102. For example, as road conditions change—prompting a detectable vehicular transition event, a driving mode user interface element may be emphasized to the vehicle user for adjusting the ride of the vehicle (such as, a sport mode, conservative mode, increased traction modes, etc.) to increase and/or decrease vehicle performance with respect to a vehicular transition event relating to the roadway.

The data may prompt a detectable vehicular transition event. For example, as road surfaces may change from improved to non-improved, from urban to country, etc., the vehicle control unit 110 may operate to emphasize a vehicle mode user interface element for facilitating a vehicle-user input, such as a “sport mode” performance level for the vehicle 100.

FIG. 2 illustrates a head unit control surface 200 of the vehicle 100 of FIG. 1. The head unit control surface 200 includes a head unit device 202, a touch screen 224, and a plurality of presented user interface elements 204.

The touch screen 224 may operate to provide visual output or graphic user interfaces such as, for example, maps, navigation, entertainment, information, infotainment, and/or combinations thereof. The visual output and/or graphic user interfaces may be manipulated, respectively via presented interface elements 204.

The touch screen 224 may include mediums capable of transmitting an optical and/or visual output such as, for example, a cathode ray tube, light emitting diodes, a liquid crystal display, a plasma display, or other two dimensional or three dimensional display that displays graphics, text or video in either monochrome or color in response to audio/visual data 262.

Moreover, the touch screen 224 may, in addition to providing visual information, detect the presence and location of a tactile input upon a surface of, or adjacent to, the touch screen 224. Additionally, it is noted that the touch screen 224 can include at least one or more processors and one or more memory modules to support the operations described herein.

The plurality of presented user interface elements 204 may include a number of movable objects that transform physical motion into a data signal that may be transmitted on a wire, light, and/or wireless basis to other user interface elements of the vehicle 100, as well as to other control units, modules, displays, etc., of the vehicle 100 (FIG. 1). Examples may include buttons, knobs, switches, microphones, eye-tracking, etc., that may be capable of transforming mechanical, optical, or electrical signals into a vehicle-user input data 260, that may be capable of transmission via a vehicle network and/or bus configuration, and operable to provide user feedback and/or responsive action(s) via the audio/visual data 262.

Tactile interfaces may include volume user interface element 206 for adjusting a volume of a media content playback via vehicle speakers, a media user interface element 208 to display application icons 225 for facilitating user input via the touch screen 224, a status user interface element 210 to prompt vehicle status data for display via the touch screen 224, and a customization user interface element 212 provides a setup configuration for the head unit 202 that may include language selection, a touch screen 224 color scheme, a touch keyboard layout, personal data deletion rules, updates, firmware versions, etc., which may be selected via the select user interface element 216 and/or 218. Hands-free operation, such as for telephone calls (via data or cellular access) via a coupled handheld mobile device (for example, a cell phone, a smart phone, a personal digital assistant (PDA) device, tablet computer, e-readers, etc.), may be selected via hands-free user interface element 222.

The select user interface element 216 may be operated by a user to search for desired media stations by turning knob of the element, as well as by pressing respective down-arrow or up-arrow buttons of the select user interface element 218. As may be appreciated, the head unit device 202 may provide a graphic user interface for user selection either by a tactile interface, such as by pressing the select user interface element 218, rotating the select user interface element 216 and entering the selection by pressing the element 216, or by touching a desired icon 225 of the graphic user interface presented by the touch screen 224.

The head unit device 202 may include various media sources selectable via the touch screen 224 and icons 225. For example, the head unit device 202 may include a disc slot 227 to receive compact discs and/or DVDs providing a media content source for playback via the touch screen 224 and/or other displays that may be present in the vehicle 100. Other selectable content sources, by way of example, may include radio (terrestrial and/or satellite), audio/visual content and/or file content provided by a coupled source (such as a mobile handheld device), or third-party content providers (for example, Pandora streaming services, etc.).

Also, the audio/visual data 262 and vehicle-user input data 260 may include other media content sources, such as audio data, hands-free phone data, voice control data, navigation data, USB connection data, DVD play function data, multifunction meter function data, illumination signal data for the touch screen 224 (such as dimming control), driving status recognition data (such as vehicle speed, reverse, etc.), or composite image signal data.

In operation, the vehicle control unit 110 may operate to provide, for example, audio/visual data 262 for display to the touch screen 224, as well as to receive vehicle-user input data 260 via a graphic user interface via the touch screen 224.

The touch screen 224 and the tactile inputs of the presented user interface elements 204 may be combined as a single module, and may operate as an audio head unit or an infotainment system of the vehicle 100. The touch screen 224 and the tactile inputs of the presented users interface elements 204 can be separate from one another and operate as a single module by exchanging signals via a communication path via vehicle-user input data 260 and/or audio/visual data 262.

In operation, the vehicle control unit 110 may operate to detect a vehicular transition event, predict a vehicle-user input response to the vehicular transition event and produce a predictive vehicle-user input response, and emphasize a subset of the presented user interface elements 204 for facilitating a vehicle user input.

The emphasis of a subset of the presented user interface elements 204 may be visual, audible, tactile, or a combination thereof. Some or all of the remaining elements 204 may also be defined in a remainder subset of the presented user interface elements 204. A first presentation output may be applied to the subset, and a second presentation output may be applied to the remainder subset to effect an “emphasis” effect to those elements corresponding to the predictive vehicle user response.

For example, the subset of the presented user interface elements 204 of FIG. 2 may include the select user interface element 216 (emphasized), and the navigation user interface element 330 (emphasized).

An example vehicular transition event may be that a radio playback source has put on a song that is in a genre that the user does not enjoy, or the vehicular transition event is that a time-of-day has occurred in which the user enjoys listening to a regularly talk radio program. Based on a predictive vehicle-user input response, the vehicle control unit 110 operates to emphasize the select user interface element 216 to facilitate a vehicle-user input. For example, in contrast to the presented vehicle user interface elements 204, the select user interface element 216 may be emphasized by increasing and/or modulating a backlighting intensity of the tactile knob module embodying the element 216. In this regard, based on specific previous actions and/or general human tendencies, the attention of the vehicle user may be directed to a subset of the presented user interface elements 204 to more readily decrease/increase volume, change radio station sources, etc.

In this manner, human-machine interface efficiency may increase because of the “predictive” action of the vehicle user, based on the vehicular transitions event (such as taste in music, desired scheduled programming) may be accommodated by directing attention to a subset of the presented user interface elements 204, instead of requiring a vehicle user to search for a likely user interface element from the plurality of presented user interface elements. Also, the choice and/or options remains with the vehicle user to engage the emphasized subset of the plurality of presented user interface elements 204, or to select a remaining one(s) to define a remainder subset of the presented user interface elements 204.

Emphasis of the subset of the presented user interface elements may be visual, audible, tactile, or a combination thereof. The presented user interface elements may be defined by a subset and a remainder subset of the presented user interface elements. A first presentation output may be applied to the subset, and a second presentation output may be applied to the remainder subset for an “emphasis” effect to those elements corresponding to the predictive vehicle user response.

For example, a visual emphasis may be based on applying a first presentation output that causes icons for a display screen, or electromechanical interface switches, to appear brighter and/or larger relative to the remainder subset of elements. In the context of a display (such as a head unit display, a heads-up display, etc.), brighter pixel combinations are applied to the subset, while duller/or subdued pixel combinations may be applied to the remainder subset.

Also, a display order of the user interface elements, such as icons, may be moved towards a vehicle user for easier access. User interface switches (such as steering wheel switches, door panel switches, dash switches, etc.), may include back-lighting elements to emphasize the device of the subset relative to a remainder subset.

Moreover, different color spectrums may be applied to on-screen and electromechanical user interface elements, as well “motion” simulated light patterns such as pulses, gradient color progression, etc. Also, user interface elements may be emphasized by haptic signaling and/or tactile feedback. Tactile feedback may convey to a vehicle user a touch sensation such as surface texture, temperature, vibration and/or a combination thereof.

The vehicle control unit 110 operates to emphasize, by way of example, the select user interface element 216 (emphasized) by increasing a light source intensity of the human-machine interface device. In operation, the “predictive” user interface element 216 appears brighter relative to the remaining plurality of presented user interface elements 204.

Also, as may be appreciated, other emphasizing techniques may be applied alone or in combination. For example, user interface elements may include light sources for back-lighting, which may also transition in colors emitted, as well as provide an optical illusion of movement by pulsing an intensity or color spectrum of the light source.

Further, the vehicle control unit may “emphasize” user interface elements by haptic signaling and/or tactile feedback. Tactile feedback may convey to a vehicle user a touch sensation such as surface texture, temperature, vibration and/or a combination thereof.

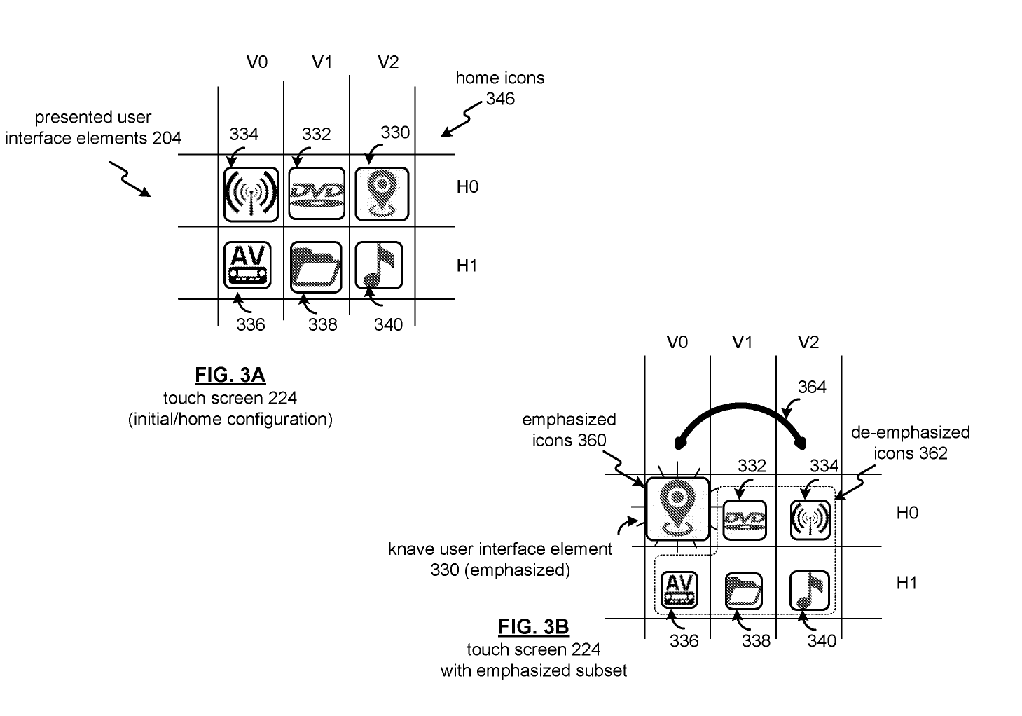

Another example of vehicular transition event may be one where a vehicle user travels to an area in which they may not be familiar. In general, the vehicle control unit 110 may operate to gather sufficient travel data to determine frequently traveled areas, and those that are not frequently traveled. Upon detecting a vehicular transition event relating to vehicle location (that is, an unfamiliar vehicle location), the vehicle control unit 110 may operate to form a predictive vehicle-user input response, and based upon the predictive vehicle-user input response, emphasize a navigation user interface element 330 of the touch screen 224 to facilitate a vehicle-user input. The emphasis of a user interface element displayed by the touch screen 224 is discussed in detail with reference to FIGS. 3A and 3B.

FIGS. 3A and 3B illustrate emphasizing a subset of a plurality of presented user interface elements 204 presented by touch screen 224 of the head unit control surface 200 of FIG. 2.

The presented user interface elements 204 may be represented by home icons 346. An icon, in graphical environments such as that presented by touch screen 224, may be understood to be small graphic images displayed on a screen to represent an object that may be manipulated by a user, such as vehicle user of the vehicle 100. Icons in general may be considered to be visual mnemonics (for example, a trash can icon may represent a command for deleting unwanted text and/or files) that may allow the vehicle user to control certain defined computer actions and/or execute applications (that is, an executable set of instructions forming a utility that may provide work-product, graphics, information, and/or perform functions when executed by a user and/or on the user's behalf), such as via the vehicle control unit 110 and/or other control units or modules of the vehicle 100, without the user having to remember or enter them via a keyboard. That is, icons can promote user-friendliness and efficiency through graphical user interfaces (GUIs).

The presented user interface elements 204 may include, for example, a radio user interface element 334 related to accessing terrestrial and/or satellite program content, a DVD or disc user interface element 334 related accessing media content of a DVD and/or disc received by disc slot 226 (FIG. 2), a navigation user interface element 330 related to accessing navigation applications (such as digital maps, location data (including GPS data), orientation relative to surroundings, etc.), an audio/visual user interface element 336 related to applications that access a content source from a device that may be coupled with the head unit device 202 (FIG. 2), a file user interface element 338 related to accessing files on internal memory and/or external memory (such as a memory stick device coupled with a data port (e.g., USB, IEEE 1394, etc.), and a media user interface element 340 related to accessing a media application (e.g., EnTune App Suite, etc.) of another device (such as a handheld mobile device 124), which may be accessible via a wireless and/or wired link.

Initial/home icons 346 for the user interface elements 330, 332, 334, 336, 338, 340 may be presented in an initial and/or home configuration display for the touch screen 224. For example, the initial configuration display may be on an n-by-m matrix configuration, with the home icons 346 may have a size and color scheme comparable to one another. That is, in an initial and/or home configuration display, a subset of the presented user interface elements 204 has not been “emphasized” based on a predictive vehicle user input response, because the vehicle control unit 110 has not detected a vehicular transition event.

Also, as may be appreciated, following a predetermined period of time or upon a user input to an emphasized user interface element of a subset of the plurality of presented user interface elements, the display of the touch screen 224 may return to an initial/home configuration of home icons 346.

FIGS. 3A and 3B are illustrations of a home display and an emphasized display for the touch screen 224 of FIG. 0.2. The example matrices of FIGS. 3A and 3B are a two-row by three-column structure sized for the display area of the touch screen 224 and identified by column grid markers V0, V1 and V2 and row grid markers H0 and H1.

As may be appreciated, other forms of graphic user interfaces (such as volume control graphics, radio simulation graphics, etc.) may also be presented in combination with home icons 346 by the touch screen 224 or as other page displays.

Referring to the example of FIG. 3B, the touch screen 224 includes an emphasized subset of the presented user interface elements 204. In the context of graphical user interfaces, various effects may be applied to visually emphasize the subset to facilitate a vehicle-user input. For example, a set of icons for a user interface element may include different sizes and brightness. Also, at the page display level, icons may be moved closer to a vehicle user to facilitate a vehicle-user input. As may also be appreciated, haptic effects may be used to permit the touch screen 224 to provide information in tactile form to the vehicle user.

For example, when the vehicle control unit 110 detects a vehicular transition event relating to a geographic area that may be unfamiliar to a vehicle user, a subset of the user interface elements 204 relating to the navigation (nav) user interface 330 may be emphasized based on a predictive vehicle-user input response.

In the example of FIG. 3B, the subset of the plurality of user interface elements 204 includes the navigation user interface element 330. The vehicle control unit 110 may emphasize the navigation user interface element 330 by using emphasized icon 360, and the remainder subset by using de-emphasized icons 362. Accordingly, navigation user interface element 330 appears larger relative to the remainder set 332, 334, 335, 338 and 335 of the plurality of user interface elements 204. Also, a pixel image of the emphasized icons 360 may include brighter, crisper color combinations, while pixel images of the de-emphasized icons 362 may include duller, less crisp color combinations.

In the alternative, should the touch screen 224 include a regional lighting control capability, lighting intensities may be adjusted, alone or in combination with the emphasized icons 360 and de-emphasized icons 362, for each of the subset and remainder subset of the plurality of using interface elements to effect an emphasis for the respective user interface elements.

As may be appreciated, each of the plurality of user interface elements may have an associated set of icons to apply an “emphasis” effect to each of the respective subset of user interface elements depending on the vehicular transition event. For example, an icon set may include a home icon pixel (picture element) image, an emphasized icon pixel image, and a de-emphasized icon pixel image.

The home icons 346 of FIG. 3A, for example, may implement an initial/home icon graphic for the initial/home configuration of the touch screen 224. In FIG. 3B, the vehicle control unit 110 may emphasize a subset of the plurality of presented user interface elements 204 by applying a respective emphasized icon graphic.

The relative size of the emphasized icon 360 may also contribute to visually emphasizing the icon 360 and to produce visually smaller de-emphasized icons 362. Moreover, different color spectrums may be applied to on-screen and electromechanical user interface elements, as well “dynamic motion” of the icon, such as pulses, gradient color progression, etc. Though an emphasized subset of the user interface elements may be presented to facilitate a vehicle-user input based on a predictive response, the vehicle user has an option to select other user interface elements of a remainder subset.

Also, a display order of the user interface elements 204, such as icons, may be moved towards a vehicle user for easier access. In the example FIG. 3A, the initial/home configuration illustrates a navigation user interface element 330 positioned in the array at (H0, V2), and a radio user interface element 334 positioned in the array at (H0, V0), which is closer to a vehicle driver's reach (for jurisdictions having right-side roadway driving). At the example of FIG. 3B, to further emphasize the subset of the plurality of presented user interface elements for facilitating a vehicle-user input, a position exchange 364 may occur. That is, the positions of the radio user interface element 334 is exchanged with that of the navigation user interface element 330. As a result, the navigation user interface element 330 is positioned at (H0, V0), and the radio user interface element 334 is positioned at (H0, V2). In the example provided, the subset may be emphasized by size, color, position, or a combination thereof.

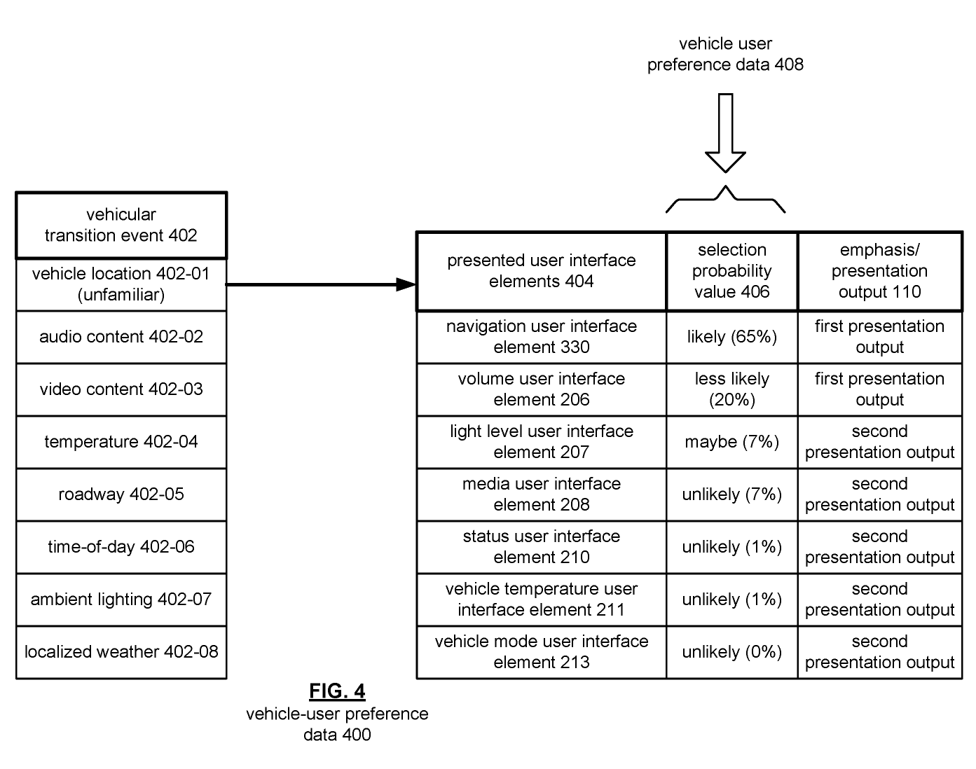

FIG. 4 illustrates vehicle-user preference data 400 for predicting a vehicle-user input response. The data 400 may be represented in a table format including a vehicular transition event 402, presented user interface elements 404, selection probability values 406, and an emphasis/presentation output 110.

The vehicular transition event 402 may include a plurality of events that may be assessed against vehicle sensor data monitored by the vehicle control unit 110. Vehicle sensor data may include data produced by vehicle sensors devices, such as sensor devices 102, 104, and/or 106 (FIG. 1), which relate to vehicle operational data. Also, a vehicular transition event 402 may be assed against biometric data of a vehicle user as monitored by the vehicle control unit 110.

Vehicle operational data may include audio content playback data (such as radio data services (RDS) data accompanying program broadcasts), video content playback data, exterior temperature data, cabin temperature data, roadway condition data, vehicle location data (such as GPS data, etc.), vehicle motion data (such as Vehicle Speed Sensor (VSS) data, braking data, etc.), time-of-day data, ambient-lighting data, localized weather data (based on vehicle moisture sensors, weather data reception, and the like), etc.

Biometric data of a vehicle user may include monitoring gaze tracking data to determine the direction of the vehicle driver's attention, skin temperature data relating to comfort (and climate control user interface elements), alertness data and/or mood data relating to vehicle driver position, attitudes, etc.

A vehicle transition event may be understood to an event that may likely prompt a vehicle user to engage a user interface element of the vehicle. Examples of vehicle transition events may include time-of-day that may prompt a vehicle user to change radio stations or content sources for a desired scheduled program or traffic reports, may include weather changes that may prompt the vehicle user to change radio stations or content sources for weather status or reports, etc.

Accordingly, the vehicular transition event 402 may be populated by an initial configuration, or may be learned/monitored over time by the vehicle control unit 110 observing vehicle user response triggered by an event (such as adjusting the climate control upon starting the vehicle, reducing audio playback, etc.). For example, the vehicular transition event 402 may include a vehicle location event 402-01, an audio content event 402-02, a video content event 402-03, a temperature event 402-04, a roadway event 402-05, a time-of-day event 402-076, an ambient lighting event 402-07, a localized weather event 402-08, etc.

Each of the events, when detected by vehicle control unit 110, operate to point and/or access presented user interface elements 420. The presented user interface elements 404 may include tactile user interface elements, graphic user interface elements, etc.

For the example of a vehicle location event 404, the presented user interface elements 420 may include a navigation user interface element 330, a volume user interface element 206, a light level user interface element 207, a media user interface element 208, a status user interface element 210, a vehicle temperature user interface element 211, a vehicle mode user interface element 213, etc.

As may be appreciated, the plurality of presented user interface elements 404 may include other user interface elements located on other vehicle control surfaces, other display surfaces, etc. For example, a steering wheel control surface may include an additional plurality of presented user interface elements located for ready access by a vehicle user's hands, and may also be included in the table of presented user interface elements 404.

In the context of the detected vehicular transition event 402, which in the example is a vehicle location 404 (such as an area not commonly traveled by a vehicle user), a selection probability value 406 corresponds with selection of respective user interface elements 330. The selection probability value may be based on fuzzy logic principles, such as “likely,” “less likely”, “maybe”, “unlikely,” or may be based empirically against total user interface interactions. For example, for sixty-five percent of the time, the navigation user interface element 330 received a vehicle-user input, and for twenty-percent of the time, a volume user interface element 206 received a vehicle user input (e.g., to minimize distraction and to allow the vehicle user to concentrate).

The vehicle control unit 110 may produce a predictive vehicle-user input response that includes the “likely” navigation user interface element 330 at sixty-five percent, and the “less likely” volume user interface element 206 at twenty-percent. A predetermined threshold may be applied to limit the number of user interface elements to emphasize, or a threshold percentage level, to avoid overwhelming a vehicle user with an excessive number of user interface element options.

Also, the selection probability value 406 may be updated based on vehicle user preference data 408 that indicates vehicle user input selections under respective vehicular transition events.

An emphasis/presentation output 110 relates to respective presented user interface elements 404 and selection probability value 406. In the example of FIG. 4, the navigation user interface element 330 and the volume user interface element 206, which are a subset of the presented user interface elements 404, have a first presentation output. A remainder subset of the presented user interface elements 404 have a second presentation output. As may be appreciated, a first presentation output for one of the subset of the presented user interface elements 404 may be different from a first presentation output for another one (or many) of the subset of the presented user interface elements 404. Also, a second presentation output for one of the remainder subset may be different from a second presentation output for another one (or many) of the remainder subset.

For a tactile user interface element (such as a button, knob, switch, etc.), the first presentation output may emphasize the element by increasing a backlighting intensity, by altering the lighting color, by pulsing a color intensity and/or color, etc. For a graphic user interface element for display, the first presentation output may emphasize the element by selecting an emphasized icon from the element icon set (that is, a brighter color scheme, larger area, location swap, etc.).

For a tactile user interface element (such as a button, knob, switch, etc.), the second presentation output may de-emphasize an element by decreasing (or not changing) a backlighting intensity, by altering to a contrasting lighting color (or no color), etc. For a graphic user interface element for display, the second presentation output may de-emphasize the element by selecting a de-emphasized icon from the element icon set (that is, a darker/dingy color scheme, same or smaller icon area, icon location swap, etc.).

In operation, the vehicle control unit may, based on a predictive vehicle-user input response, emphasize a subset of the plurality of user interface elements.

The emphasis of the subset of the presented user interface elements may be visual, audible, or a combination thereof. The presented user interface elements may be defined by a subset and a remainder subset of the presented user interface elements. A first presentation output may be applied to the subset, and a second presentation output may be applied to the remainder subset to effect an “emphasis” effect to those elements corresponding to the predictive vehicle user response.

For example, a visual emphasis may be based on applying the first presentation output that causes icons for a display screen, or electromechanical interface switches, to appear brighter and/or larger relative to the remainder subset of elements. In the context of a display (such as a head unit display, a heads-up display, etc.), brighter pixel combinations are applied to the subset, while duller/or subdued pixel combinations may be applied to the remainder subset.

Also, a display order of the user interface elements, such as icons, may be moved towards a vehicle user for easier access. User interface switches (such as steering wheel switches, door panel switches, dash switches, etc.), may include back-lighting elements to emphasize the device of the subset relative to a remainder subset.

Moreover, different color spectrums may be applied to on-screen and electromechanical user interface elements, as well “motion” simulated display such as pulses, gradient color progression, etc. Also, user interface elements may be emphasized by haptic signaling and/or tactile feedback. Tactile feedback may convey to a vehicle user a touch sensation such as surface texture, temperature, vibration and/or a combination thereof.

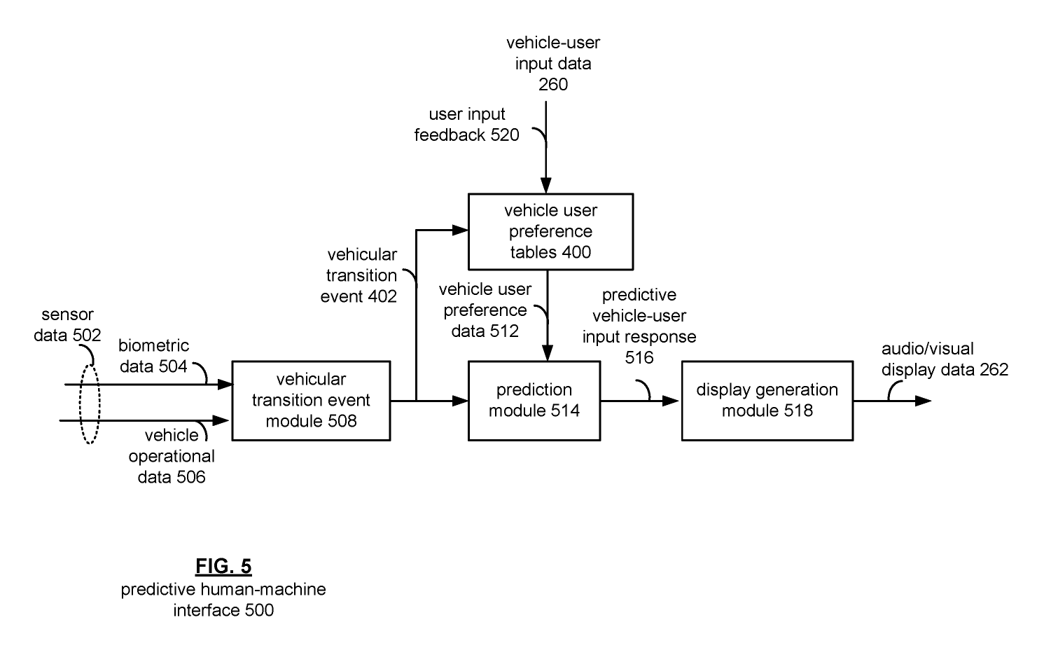

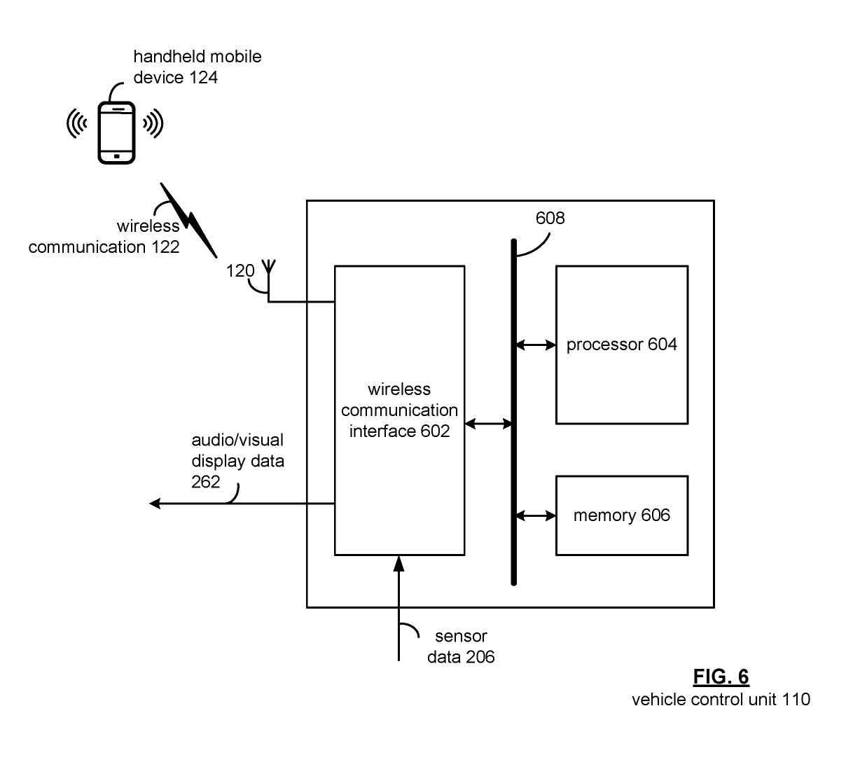

FIG. 5 illustrates a functional block diagram for a predictive human-machine interface 500 of the vehicle control unit 110. The predictive human-machine interface 500 may include a vehicular transition event module 508, a prediction module 514, a display generation module, and vehicle user preference tables 400. As may be appreciated, an example embodiment of the vehicle control unit 110 including a processor, memory, wireless communication interface, etc., is discussed in detail with reference to FIG. 6.

In operation, the vehicular transition event module 508 generally includes instructions that function to control a processor to retrieve sensor data (e.g., data stored in memory or from sensors of a vehicle sensor array) and analyze the sensor data 502 to produce vehicular transition event 510 upon detection by the vehicle control unit 110.

The sensor data 502 may include biometric data 504 and vehicle operational data 506, by which a vehicle control unit 110 may operate to detect a vehicular transition event 402 based on the vehicle sensor data 502. The vehicular transition event 402 may include a plurality of events that may be assessed against vehicle sensor data monitored by the vehicle control unit 110.

Vehicle sensor data 502 may include data produced by vehicle sensors devices, such as sensor devices 102, 104, and/or 106 (FIG. 1), which in turn relate to vehicle operational data 506. Also, a vehicular transition event 402 may be assessed against biometric data 504 of a vehicle user as monitored by the vehicle control unit 110 via the vehicular transition event module 508.

The prediction module 514 generally includes instructions that function to control a processor to receive the vehicular transition event 510, and to retrieve vehicle users preference data 512, from the vehicle preference tables 400 (see FIG. 4). A configuration of

The prediction module 514 determines whether the vehicular transition event 402 relates to at least one of a plurality of presented user interface elements (such as tactile user interfaces including buttons, switches, knobs, etc., and graphic user interfaces such as selectable user interface elements of a display screen via touch or selection via a tactile user interface element. The vehicle user preference data 512 may include a selection probability value for each of the plurality of presented user interface elements to base, at least in part, the predictive vehicle-user input response 516 provided to the display generation module 518.

When the vehicular transition event 402 relates to at least one of the plurality of presented user interface elements, the prediction module 514 may operate to predict a vehicular transition event based on vehicle use preference data 512 to produce a predictive vehicle-user input response 516.

The display generation module 518 generally includes instructions that function to control a processor to receive the predictive vehicle-user response 516, and generate audio/visual display data 262 based on the predictive vehicle-user input response. In operation, the display generation module 518 may retrieve a corresponding emphasis/presentation output 110 of a subset of the plurality of predicted user interface elements 404. The emphasis/presentation output 110 may be a first presentation output for the subset, and a second presentation output for a remainder subset of the plurality of presented user interface elements 404 (FIG. 4). In this manner, the predictive human-machine interface 500 may operate to emphasize a subset of the plurality of presented user interface elements for facilitating a vehicle-user input.

The predictive human-machine interface 500 may operate to receive vehicle-user input data 260. The vehicle-user input data 260 provides user input feedback 520 that may operate to discern vehicle user trends. That is, based on which of the plurality of presented vehicle user interface elements are selected by the user in view of vehicular transition event, the selection probability values may be updated and/or populated.

As may also be appreciated, the vehicle-user input data 260 may be used as user input feedback 520 to update the vehicle-user preference tables 400 during a vehicular transition event, in which the selection probability value may be generated and/o updated for each of the plurality of presented user interface elements, based on the vehicular transition event 402.

FIG. 6 is a block diagram of a vehicle control unit 110, which includes a wireless communication interface 602, a processor 604, and memory 606, that are communicatively coupled via a bus 608. The vehicle control unit 110 may provide an example platform for the device and methods described in detail with reference to FIGS. 1-7.

The processor 604 of the vehicle control unit 110 can be a conventional central processing unit or any other type of device, or multiple devices, capable of manipulating or processing information. As may be appreciated, processor 604 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory (and/or memory element) 606 may be communicably coupled to the processor 604, and may operate to store one or more modules, at least some of which are described herein. The modules can include instructions that, when executed, cause the processor to implement one or more of the various processes and/or operations described herein.

The memory and/or memory element 606 may be a single memory device, a plurality of memory devices, and/or embedded circuitry of the processing module 804. Such a memory device may be a read-only memory, random access memory, volatile memory, non-volatile memory, static memory, dynamic memory, flash memory, cache memory, and/or any device that stores digital information. Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. In the context of this document, a computer-readable storage medium may be any tangible medium that can contain, or store a program for use by or in connection with an instruction execution system, apparatus, or device.

The memory 606 is capable of storing machine readable instructions, or instructions, such that the machine readable instructions can be accessed by the processor 804. The machine readable instructions can comprise logic or algorithm(s) written in programming languages, and generations thereof, (e.g., 1GL, 2GL, 3GL, 4GL, or 5GL) such as, for example, machine language that may be directly executed by the processor 604, or assembly language, object-oriented programming (OOP), scripting languages, microcode, etc., that may be compiled or assembled into machine readable instructions and stored on the memory 606. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 604 includes more than one processing device, the processing devices may be centrally located (e.g., directly coupled together via a wired and/or wireless bus structure) or may be distributed located (e.g., cloud computing via indirect coupling via a local area network and/or a wide area network). Further note that when the processor 604 implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry.

Still further note that, the memory 606 stores, and the processor 604 executes, hard coded and/or operational instructions corresponding to at least some of the steps and/or functions illustrated in FIGS. 1-7. The vehicle control unit 110 is operable to receive, via the wireless communication interface 602, sensor data 206 including at least one of vehicle operational data and/or vehicle user biometric data. The vehicle control unit 110 may operate to detect a vehicular transition event, upon which the vehicle control unit may operate to predict a vehicle-user input response to the vehicular transition event to produce a predictive vehicle-user input response. Based on the predictive vehicle-user input response, the vehicle control unit 110 may generate audio/visual display data 262 for emphasizing a subset of a plurality of presented user interface elements to facilitate a vehicle-user input.

The vehicle control unit 110 can include one or more modules, at least some of which are described herein. The modules can be implemented as computer-readable program code that, when executed by a processor 604, implement one or more of the various processes described herein. One or more of the modules can be a component of the processor(s) 604, or one or more of the modules can be executed on and/or distributed among other processing systems to which the processor(s) 604 is operatively connected. The modules can include instructions (e.g., program logic) executable by one or more processor(s) 604. Alternatively, or in addition, one or more data store 115 may contain such instructions.

The wireless communications interface 602 generally governs and manages the data received via a vehicle network and/or the wireless communication 122. There is no restriction on the present disclosure operating on any particular hardware arrangement and therefore the basic features herein may be substituted, removed, added to, or otherwise modified for improved hardware and/or firmware arrangements as they may develop.

The antenna 120, with the wireless communications interface 602, operates to provide wireless communications with the vehicle control unit 110, including wireless communication 122.

Such wireless communications range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, 3GPP (3rd Generation Partnership Project), 4GPP (4th Generation Partnership Project), 5GPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), and/or variations thereof.

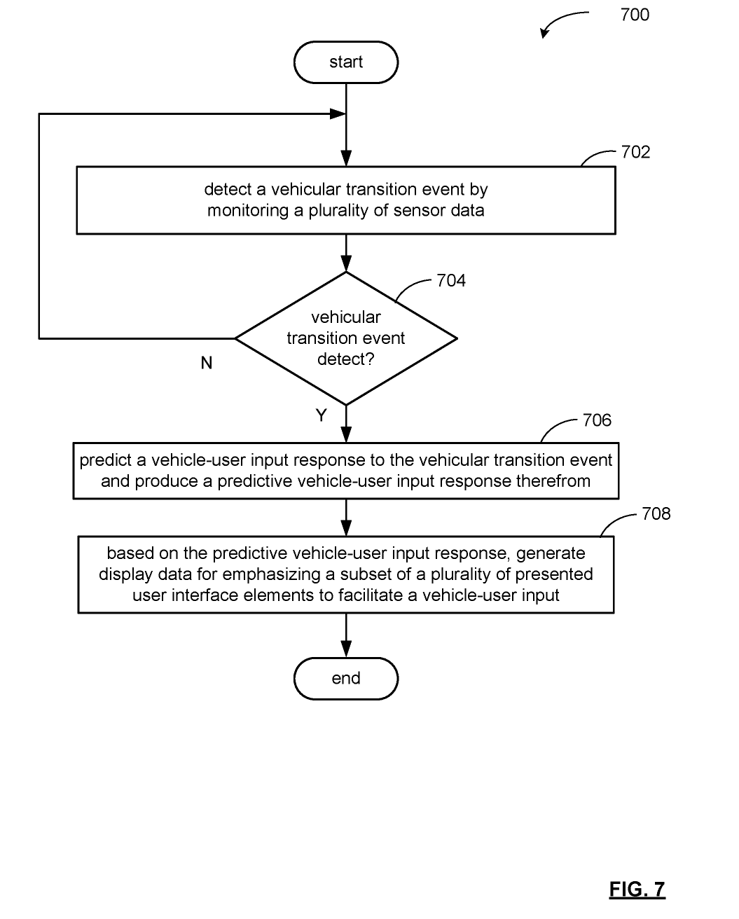

FIG. 7 shows an example process 700 for a predictive vehicular human-machine interface in a vehicle control unit 110.

At operation 702, the vehicle control unit 110 detects a vehicular transition event by monitoring a plurality of sensor data. As may be appreciated, the plurality of sensor data may include at least one of vehicle operational data and vehicle user biometric data. Examples of a vehicular transition event may be a speed decrease, approaching traffic congestion, a change in weather conditions, a change in terrestrial/satellite radio station content, etc. Without more, a vehicle user may seek out, without assistance, one of a plurality of presented user interface elements in response to the vehicular transition event. The presented user interface elements may include at least two of a volume level user interface element, a light level user interface element, a media channel user interface element, a vehicle mode user interface element; a vehicle temperature user interface element, etc.

When a vehicular transition event is detected at operation 704, the vehicle control unit 110, at operation 706, predicts a vehicle-user input response to the vehicular transition event based on vehicle user preference data to produce a predictive vehicle-user input response when the vehicular transition event relates to at least one of a plurality of presented user interface elements.

For predicting a vehicle-user response, the vehicle control unit may retrieve vehicle user preference data based on the vehicular transition event. The vehicle user preference data may include a selection probability value for each of the plurality of presented user interface elements. With the vehicle user preference data, the vehicle control unit may generate the predictive vehicle-user input response.

At operation 708, the vehicle control unit 110, based on the predictive vehicle-user input response, generates display data for emphasizing a subset of the plurality of presented user interface elements to facilitate a vehicle-user input. The display data may operate to emphasize the subset relative to a remainder subset of the plurality of presented user interface elements.

To emphasize the subset of the plurality of presented user interface elements, the vehicle user preference data may further include a first presentation output and a second presentation output for each of the plurality of presented user interface elements. When an element is part of the subset, the first presentation output may be applied. When an element is part of the remainder subset, the second presentation output may be applied. As may be appreciated, each of the first and the second presentation output includes at least one of an icon size, a light pattern (such as intensity cycling, strobe effect, color transition, etc.), an icon coloration (such as dimming, animation, brightness, etc., that relate to a screen display), and a light intensity (such as may be applied to tactile user interface elements (that is, switches, buttons, knobs, etc.).

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Program code and/or instructions embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

Thus, there has been described herein an apparatus and method, as well as several embodiments including a preferred embodiment, for implementing a predictive human-machine interface in view of vehicular transition event.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretations so as to encompass all such modifications and equivalent structures as is permitted under the law.

What is claimed is:

1. A method for a predictive vehicular human-machine interface, the method comprising:
detecting a vehicular transition event by monitoring a plurality of sensor data;
when the vehicular transition event occurs, predicting a vehicle-user input response to the vehicular transition event and producing a predictive vehicle-user input response; and
based on the predictive vehicle-user input response, generating display data for emphasizing a subset of a plurality of presented user interface elements to facilitate a vehicle-user input.

2. The method of claim 1, wherein the plurality of sensor data comprises at least one of:
biometric data of a vehicle user; and
vehicle operational data.

3. The method of claim 2, wherein the vehicle operational data further comprises at least one of:
audio content playback data;
video content playback data;
exterior temperature data;
cabin temperature data;
roadway condition data;
vehicle location data;
vehicle motion data;
time-of-day data;
ambient-lighting data; and
localized weather data.

4. The method of claim 1, wherein the plurality of presented user interface elements comprises at least two of:
a volume user interface element;
a light level user interface element;
a media user interface element;
a vehicle mode user interface element;
a vehicle temperature user interface element; and
a navigation user interface element.

5. The method of claim 1, wherein the predicting the vehicle-user input response to the vehicular transition event and the producing the predictive vehicle-user response further comprises:
retrieving vehicle-user preference data based on the vehicular transition event, the vehicle-user preference data including a selection probability value for each of the plurality of presented user interface elements; and
generating, from the vehicle-user preference data, the predictive vehicle-user input response.

6. The method of claim 5 further comprising:
updating the vehicle-user preference data by:
recording the vehicle-user input during the vehicular transition event; and
generating the selection probability value for the each of the plurality of presented user interface elements based on the vehicular transition event.

7. The method of claim 1, wherein the emphasizing the subset of the plurality of presented user interface elements for facilitating the vehicle-user input response further comprises:
selecting a first presentation output to the subset of the plurality of presented user interface elements;
selecting a second presentation output to a remainder subset of the plurality of presented user interface elements, wherein the first presentation output and the second presentation output operate to emphasize the at least the portion of the subset of the plurality of presented user interface elements; and
generate the display data based on the first presentation output and the second presentation output.

8. The method of claim 7, wherein:
the first presentation output includes at least one of a first icon size, a first icon coloration, and a first light pattern; and
the second presentation output includes at least one of a second icon size, a second icon coloration, and a second light pattern.

9. A method for a predictive vehicular human-machine interface, the method comprising:
receiving a plurality of vehicle sensor data, wherein the vehicle sensor data includes at least one of vehicle operational data and vehicle user biometric data;
detecting a vehicular transition event based on the plurality of vehicle sensor data;
determining whether the vehicular transition event relates to at least one of a plurality of presented user interface elements; and
when the vehicular transition event relates to the at least one of the plurality of presented user interface elements:
predicting a vehicle-user input response to the vehicular transition event based on vehicle-user preference data to produce a predictive vehicle-user input response; and
based on the predictive vehicle-user input response, generating display data for emphasizing a subset of the plurality of presented user interface elements relative to a remainder subset of the plurality of presented user interface elements to facilitate a vehicle-user input.

10. The method of claim 9, wherein the vehicle operational data further comprises at least one of:
audio content playback data;
video content playback data;
exterior temperature data;
cabin temperature data;
roadway condition data;
vehicle location data;
vehicle motion data;
time-of-day data;
ambient-lighting data; and
localized weather data.

11. The method of claim 9, wherein the plurality of presented user interface elements comprises at least two of:
a volume level user interface element;
a light level user interface element;
a media channel user interface element;
a vehicle mode user interface element; and
a vehicle temperature user interface element.

12. The method of claim 9, wherein the predicting the vehicle-user input response to the vehicular transition event based on the vehicle-user preference data to produce the predictive vehicle-user input response further comprising:
retrieving vehicle-user preference data based on the vehicular transition event, the vehicle-user preference data including a selection probability value for each of the plurality of presented user interface elements; and
generating, from the vehicle-user preference data, the predictive vehicle-user input response.

13. The method of claim 12 further comprising:
updating the vehicle-user preference data by:
recording the vehicle-user input during the vehicular transition event; and
generating the selection probability value for the each of the plurality of presented user interface elements based on the vehicular transition event.

14. The method of claim 9, wherein the emphasizing a subset of a plurality of presented user interface elements for facilitating a vehicle-user input further comprising:
selecting a first presentation output to the subset of the plurality of presented user interface elements;
selecting a second presentation output to a remainder subset of the plurality of presented user interface elements, wherein the first presentation output and the second presentation output operate to emphasize the at least the portion of the subset of the plurality of presented user interface elements; and
generate the display data based on the first presentation output and the second presentation output.

15. The method of claim 14, wherein:
the first presentation output includes at least one of a first icon size, a first icon coloration, and a first light intensity; and
the second presentation output includes at least one of a second icon size, a second icon coloration, and a second light intensity.

16. A predictive vehicular human-machine interface device comprising:
a processor;
memory communicably coupled to the processor and storing:
a vehicular transition event module including instructions that when executed cause the processor to detect a vehicular transition event based on a plurality of sensor data;
a prediction module including instructions that when executed by the processor predict a vehicle-user input response to the vehicular transition event and generating a predictive vehicle-user input response therefrom; and
a display generation module including instructions that when executed by the processor generates, based on the predictive vehicle-user input response, display data to emphasize a subset of a plurality of presented user interface elements for facilitating a vehicle-user input.

17. The predictive vehicular human-machine interface device of claim 16, wherein the vehicular transition event module includes instructions to detect the vehicular transition event by monitoring at least one of:
biometric data of a vehicle user from the plurality of sensor data; and
vehicle operational data from the plurality of sensor data.

18. The predictive vehicular human-machine interface device of claim 16, wherein the prediction module further includes instructions to predict the vehicle-user input response and to generate the predictive vehicle-user response, the prediction module operable to:
retrieve vehicle-user preference data based on the vehicular transition event, the vehicle-user preference data including a selection probability value for each of the plurality of presented user interface elements; and
generate, from the vehicle user preference data, the predictive vehicle-user input response.

19. The predictive vehicular human-machine interface device of claim 16, wherein the display generation module further includes instructions to emphasize the subset of a plurality of presented user interface elements to facilitate the vehicle-user input, the display generation module operable to:
identify the plurality of presented user interface elements;
determine whether at least one of the plurality of presented user interface elements correspond to the predictive vehicle-user response;
when the at least one of the plurality of presented user interface elements corresponds to the predictive vehicle-user response:
produce the subset of the plurality of presented user interface elements having a first presentation output from the at least one of the plurality of presented user interface elements;
produce a remainder subset of the plurality of presented user interface elements having a second presentation output from remaining ones of the plurality of presented user interface elements, wherein the first presentation output and the second presentation output operate to emphasize the subset of the plurality of presented user interface elements; and
present the subset and the remainder subset of the plurality of presented user interface elements for the facilitating the vehicle-user input.

20. The predictive vehicular human-machine interface device of claim 19, wherein:
the first presentation output includes at least one of a first icon size, a first icon coloration, and a first light pattern; and
the second presentation output includes at least one of a second icon size, a second icon coloration, and a second light pattern.
